(19) United States
(12) Patent Application Publication
(10) Pub. No.: US 2008/0138676 A1
(43) Pub. Date: Jun. 12, 2008

(54) METHODS AND SYSTEMS OF PRODUCING MOLECULAR HYDROGEN USING A PLASMA SYSTEM IN COMBINATION WITH A MEMBRANE SEPARATION SYSTEM

(76) Inventor: Charles Terrel Adams, Spicewood, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/874,711

(22) Filed: Oct. 18, 2007

Related U.S. Application Data
(60) Provisional application No. 60/853,233, filed on Oct. 20, 2006.

(51) Int. Cl. H01M 8/04; B01J 19/08; B01D 37/00

(52) U.S. Cl. 429/17; 422/186.04; 95/273

(57) ABSTRACT

Systems and methods for production of molecular hydrogen are described herein. Systems may include a plasma reformer and a membrane separation system. The plasma reformer may produce a gas stream from the liquid feed. The gas stream may include molecular hydrogen and carbon oxides. The membrane separation system may produce a molecular hydrogen stream from the gas stream generated in the plasma reformer. The gas stream and/or molecular hydrogen may be used as a fuel in a fuel cell.

### PRIORITY CLAIM

This application claims priority to U.S. Provisional Patent Application No. 60/853,233 entitled “METHOD OF HYDROGEN PRODUCTION USING NON-THERMAL PLASMA REFORMING OF OXYGENATED OR NON-OXYGENATED HYDROCARBONS” filed Oct. 20, 2006.

### BACKGROUND

1. Field of the Invention

The present invention relates to molecular hydrogen generation. More particularly, the invention relates to systems and methods for molecular hydrogen generation using a low-temperature plasma reformer.

2. Brief Description of the Related Art

The use of fuel cells as a means to generate electricity in an efficient and environmentally safe manner has increased over time. Fuel cells are gaining widespread acceptance as a power source for stationary devices and mobile devices. Most fuel cells require molecular hydrogen as a fuel source. Since molecular hydrogen is not a natural resource, it is typically generated from one or more compounds containing hydrogen. For example, molecular hydrogen may be generated by steam reforming of hydrocarbons. During reforming, carbon monoxide is generated in addition to the desired molecular hydrogen. Carbon monoxide in the feed to a fuel cell may render the fuel cell ineffective through inhibition of the active fuel cell catalyst and/or through formation of carbon in the fuel cell. Thus, the generated gas stream is typically treated to reduce the amount of carbon monoxide in the gas stream so that the gas stream is suitable for use in some fuel cells.

Steam reforming of hydrocarbons is an endothermic process. Therefore, a source of heat must be available to start and/or run the steam reforming process. The processing equipment needed and/or the time for heating of the reactor to generate a temperature sufficient to generate molecular hydrogen using a steam methane reforming process does not make steam reforming of hydrocarbons amenable for rapid-start, compact, portable applications.

U.S. Pat. Nos. 6,976,353 to Daniel et al.; 6,903,259 to Ciray et al.; 6,804,950 to Kong et al.; and 6,793,899 to Bromberg et al. and U.S. Published Patent Application Nos. 2007/0059235 to Voecks et al.; 2004/0206618 to Voecks et al.; 2004/0148860 to Fletcher, each of which are incorporated herein by reference, describe reforming hydrocarbons and/or gaseous hydrocarbons using plasma.

Since molecular hydrogen is a produced resource and hydrogen resources such as crude oil are becoming diminished, economical and efficient methods, and systems to generate molecular hydrogen for fuel cells from alternate sources of feed are desirable.

### SUMMARY

Systems and methods for producing molecular hydrogen from a low-temperature plasma reformer are described herein.

In some embodiments, a system for production of molecular hydrogen includes a plasma reformer. The plasma reformer may receive a liquid feed and produce a gas stream from the liquid feed. The plasma reformer may generate a plasma having a temperature of at most about 400° C. In some embodiments, a pressure in the plasma reformer is between about 0.3 atmospheres and about 5 atmospheres. The gas stream may include molecular hydrogen and carbon oxides.

In some embodiments, the plasma reformer is in fluid communication with an electrical swing adsorption separation system. The electrical swing adsorption separation system may remove at least a portion of the carbon oxides from the gas stream to produce a gas stream enriched in molecular hydrogen as compared to the gas stream entering the electrical swing adsorption system.

In some embodiments, the plasma reformer is in fluid communication with a membrane separation system. The membrane separation system is configured to separate at least a portion of the carbon oxides from the gas stream to produce a gas stream enriched in molecular hydrogen as compared to the gas stream entering the membrane separation system.

In some embodiments, the plasma reformer comprises a water gas shift catalyst. The water gas shift catalyst may contact the gas stream and convert at least a portion of the carbon monoxide to carbon dioxide.

In some embodiments, the plasma reformer is coupled to a fuel cell. In an alternate embodiment, the plasma reformer is coupled to a separation system and the separation system is coupled to a fuel cell.

Methods to produce molecular hydrogen using the above describe systems are also described herein. In some embodiments, a method to produce molecular hydrogen may include providing a liquid feed to a plasma reformer. In the plasma reformer, the liquid feed may be converted to a gas stream that includes molecular hydrogen. In some embodiments, the gas stream includes carbon monoxide and/or carbon dioxide. The gas stream may be provided to one or more fuel cells. In some embodiments, the gas stream is provided to a separation system. The separation system may separate the molecular hydrogen from other components in the gas stream to form a molecular hydrogen stream. The molecular hydrogen stream may be provided to one or more fuel cells.

In some embodiments, the gas stream is contacted with a water gas shift catalyst. Contact of the gas stream with the water gas shift catalyst may convert a portion of the carbon monoxide in the gas stream to a molecular hydrogen enriched gas stream as compared to the gas stream prior to contact with the water gas shift catalyst. Such molecular hydrogen enriched gas stream may be separated in a separation system and/or provided to one or more fuel cells.

### BRIEF DESCRIPTION OF THE DRAWINGS

Features and advantages of the methods and apparatus of the present invention will be more fully appreciated by reference to the following detailed description of presently preferred but nonetheless illustrative embodiments in accordance with the present invention when taken in conjunction with the accompanying drawings.

FIG. 1 depicts an embodiment of a plasma reformer system.

FIG. 2 depicts an embodiment of an electrode configuration in a plasma reformer.

FIGS. 3A and 3B depict embodiments of a plasma reformer that includes dielectric barriers.

FIG. 4 depicts an embodiment of an electrode that includes one or more pointed elongated members.

FIG. 5 depicts bottom view of an embodiment of an electrode that includes one or more convex elongated members.

FIG. 6 depicts an embodiment of an electrode that includes openings.

FIG. 7 depicts an embodiment of top view of an electrode.

FIG. 8 depicts a schematic representation of an embodiment of flow through a plasma reformer.

FIG. 9 depicts an embodiment of a plasma reformer system that includes a catalyst.

FIG. 10 depicts an embodiment of a plasma reformer that includes a catalyst zone.

FIG. 11 depicts plasma reformer with membrane separation system inside the reformer.

FIG. 12 depicts an embodiment of a plasma reformer with a membrane separation system coupled to the plasma reformer.

FIG. 13 depicts an embodiment of a plasma reformer with an electrical swing adsorption system.

FIG. 14 depicts plasma reformer that includes a catalyst system and a membrane separation system.

FIG. 15 depicts an embodiment of a plasma reformer that includes a catalyst and a membrane separation system.

FIG. 16 depicts an embodiment of a plasma reformer that includes a catalyst and an electrical swing adsorption system.

FIG. 17 depicts a system that includes a plasma reformer system and a fuel cell.

FIG. 18 depicts a system that includes a plasma reformer system, a membrane separation system, and a fuel cell.

FIG. 19 depicts an embodiment of a system to produce molecular hydrogen that includes a plasma reformer, a catalyst system, a membrane separation system, and a fuel cell.

FIG. 20 depicts an embodiment of a system to produce molecular hydrogen that includes a plasma reformer, an electrical swing adsorption separation system, and a fuel cell.

FIG. 21 depicts an embodiment of a system to produce molecular hydrogen that includes a plasma reformer, a catalyst system, an electric swing adsorption separation system, and a fuel cell.

FIG. 22 depicts a system that includes a plasma reformer system, a purification system, and a fuel cell.

While the invention is susceptible to various modifications and alternative forms, specific embodiments thereof are shown by way of example in the drawings and will herein be described in detail. The drawings may not be to scale. It should be understood that the drawings and detailed description thereto are not intended to limit the invention to the particular form disclosed, but to the contrary, the intention is to cover all modifications, equivalents and alternatives falling within the spirit and scope of the present invention as defined by the appended claims.

### DETAILED DESCRIPTION

Methods and systems for making and using molecular hydrogen generated from a liquid feed using a low-temperature plasma reformer are described herein. Selected terms used herein are listed below.

“Carbon oxides” refers to carbon monoxide and/or carbon dioxide.

“Fuel cell” refers to an electrochemical device that converts chemical energy of a reaction directly into electrical energy. Fuel cells include, but are not limited to, a polymer electrolyte membrane fuel cell (PEM), an alkaline fuel cell, a phosphoric acid fuel cell, a molten carbonate fuel cell, or a solid oxide fuel cell.

“Gas” refers to one or more compounds that do not condense at 0.101 MPa and 25° C.

“Liquid” refers to one or more compounds that condense at 0.101 MPa and 25° C.

“Low-temperature plasma” refers to plasma generated at temperatures of at most about 400° C.

“Molecular hydrogen” refers to H₂.

“Oxygenated hydrocarbons” refers to one or more compounds that have carbon, hydrogen and oxygen in their composition. Oxygenated hydrocarbons include, but are not limited to, alcohols (for example, methanol and/or ethanol), aldehydes, ketones, carboxylic acids, peroxides, esters, or mixtures thereof.

“Periodic Table” refers to the Periodic Table as defined by the International Union of Pure and Applied Chemistry, June 2007.

Fuel cells may be used to provide electricity to isolated and/or remote areas of the world that do not have access to power plants and/or other sources of electricity. Fuel cells that produce electricity for 1 KW to 10 KW, 2 KW to 8 KW or 3 KW to 5 KW applications may be useful for providing electricity to isolated and/or remote areas of the world. Fuel cells that produce electricity for 1 KW to 10 KW applications may be compact. Additionally, 1 KW to 10 KW fuel cells may be useful to supply electricity for industrial and/or residential applications when power failures have occurred. For example, a fuel cell that supplies 1 KW to 10 KW of electricity may be used to power various equipment used in a hospital during a power outage.

To generate electricity, gaseous fuels (for example, H₂) may be continuously fed to an anode (negative electrode) compartment and an oxidant (for example, air-containing oxygen) may be continuously fed to a cathode (positive electrode) compartment of a fuel cell. An electrochemical reaction takes place at the electrodes to produce an electric current. When using molecular hydrogen as a fuel gas, the reaction in a fuel cell is represented by:

H₂+O₂→e⁻+H₂O

Fuel cells differ from batteries in that fuel cells have the capability of producing electrical energy for as long as the fuel and oxidant are supplied to the electrodes. Due to the diminishing supply of hydrocarbons as a fuel source, the use of liquid oxygenated hydrocarbons (for example, alcohols) as a fuel source has increased. Bio-derived renewable liquid fuel that has a high volumetric energy density may be a suitable alternate source of feed. For example, liquid oxygenated hydrocarbons derived from natural sources such as sugar, cellulose, or carbohydrates have been found suitable for use as a fuel source. Renewable liquid fuels may not require specially constructed vessels for transportation. For example, liquid oxygenated hydrocarbons may be safer and more easily transported to isolated and/or remote areas of the world than gaseous hydrocarbons since they do not require pressurized vessels. In addition, liquid oxygenated hydrocarbons may be more accessible as a fuel source than hydrocarbons currently produced from crude oil. For example, ethanol produced from sugar cane may be easier to produce for some areas of the world than producing hydrocarbons from a formation.

Liquid oxygenated hydrocarbons may provide a high concentration of molecular hydrogen. For example, reformation of ethanol in the presence of water produces carbon monoxide and molecular hydrogen as shown below:

C₂H₅OH+H₂O→2CO+4H₂ Δ_{f}=+260 kJ mol⁻¹

Because the reaction is endothermic (a positive heat of formation), reformation processes for alcohols and/or hydrocarbons are typically performed at temperatures ranging from about 700° C. to about 1000° C. In addition, the reformation reaction produces carbon monoxide. Some fuel cells may not be tolerant and/or become poisoned by carbon monoxide. For example, PEM fuel cells use platinum membranes that may be poisoned by carbon monoxide.

Carbon monoxide may be converted to carbon dioxide and molecular hydrogen using the water gas shift reaction as shown below:

CO+H₂O→CO₂+H₂ Δ_{f}=−41.7 kJ mol⁻¹

The endothermic characteristic of the reformation reaction and the need to separate and/or convert the carbon monoxide from the molecular hydrogen for use in fuel cells detracts from using conventional oxygenated hydrocarbon reforming processes to produce molecular hydrogen as a fuel for fuel cells.

In some embodiments, low-temperature plasma is used to convert liquid oxygenated hydrocarbons and/or a mixture of liquid oxygenated hydrocarbons and hydrocarbons to a gas stream that includes, but is not limited to, molecular hydrogen, carbon monoxide, and hydrocarbons having a carbon number of at most 3, without a substantial requirement for heat. In some embodiments, a mixture of liquid oxygenated hydrocarbons and water may be used as a feed to the plasma reformer. A ratio of liquid oxygenated hydrocarbons to water ratio may be about 5:1, about 4:1 to about 3:1, or about 2:1. In some embodiments, a ratio of water to liquid oxygenated hydrocarbon is about 1:1, 2:1, 3:1, 10:1, 30:1 or 50:1.

Low-temperature plasma may be generated by a dielectric barrier discharge generator, a pulsed corona discharge-type plasma generator, a silent discharge plasma generator, a radio frequency generator, a microwave generator, or combinations thereof. In some embodiments, plasma is generated by pulsing alternating current (AC) or pulsing direct current (DC). This type of plasma generation does not require an arc to generate the plasma. Plasma generated using non-arcing techniques may inhibit the formation of undesirable products, for example, coke and/or hydrocarbons with a carbon number of at least 3.

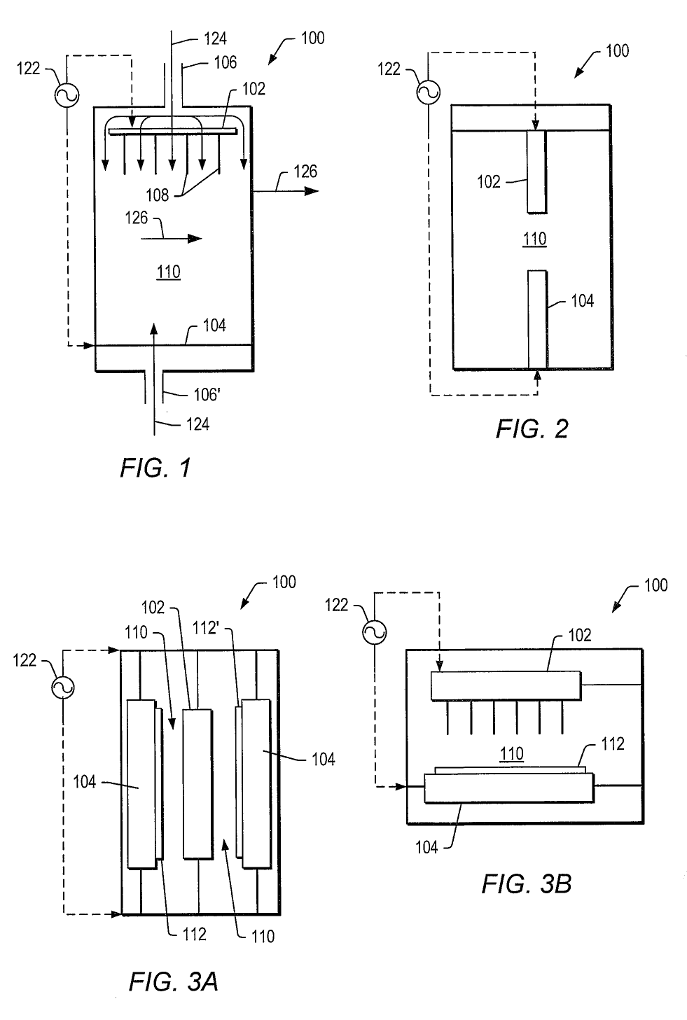

FIG. 1 depicts an embodiment of a plasma reformer system. As shown in FIG. 1, plasma reformer 100 includes electrode 102, electrode 104, and ports 106, 106′. As shown, electrode 102 may include one or more elongated members 108. In an alternate embodiment electrode 102 and/or electrode 104 include one or more elongated members 108. Electrode 102 and electrode 104 form an electrical circuit that generates plasma. In some embodiments, electrode 102 serves as an anode and electrode 104 serves as the cathode of the electrical circuit. In other embodiments, electrode 104 serves as an anode and electrode 102 serve as the cathode of the electrical circuit. FIG. 2 depicts an alternate embodiment of an electrode configuration in a plasma reformer. As shown in FIG. 2, electrodes 102 and 104 are single electrodes positioned opposite one another.

Electrode 102 and electrode 104 are positioned to form gap 110. A height of gap 110 may range from about 1 millimeter (mm) to about 100 mm, about 5 mm to about 80 mm or from about 10 mm to about 50 mm. In some embodiments, a height of gap 110 is at most about 20 mm. Gap 110 should have sufficient dimensions to sustain plasma for generating molecular hydrogen from liquid oxygenated hydrocarbons. It should be understood that an orientation of electrode 102 relative to electrode 104 (see FIGS. 1-4) may be of any orientation sufficient to sustain plasma in gap 110.

In some embodiments, one or more electrodes may include one or more dielectric barriers. FIGS. 3A and 3B depict embodiments of a plasma reformer that includes dielectric barriers. As shown in FIG. 3A, dielectric barriers 112, 112′ may be connected to the outer surface of electrode 104. Dielectric barriers 112, 112′ may be formed by metallization of the surface of electrode 104 with one or more electrically conductive materials. Gap 110 is formed between dielectric barriers 112, 112′ and electrode 102. Dielectric barriers 112, 112′ be formed of materials including, but not limited to, a ceramic material of high dielectric constant and/or titanium. FIG. 3B depicts plasma reformer 100 with one dielectric barrier. Use of dielectric barriers may enhance the activation energy of the plasma. An enhanced activation energy may assist in pushing the reforming reaction to completion, thus more hydrogen per gram of feed is formed.

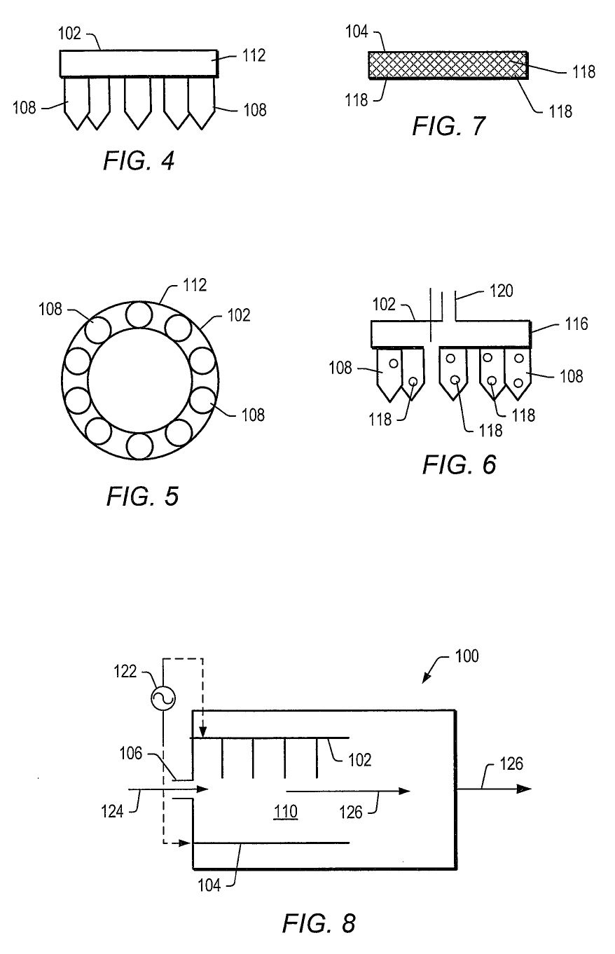

Electrode 102 and electrode 104 may be manufactured from stainless steel, carbon, or any material suitable for transfer of electrical charge that is sufficient to generate plasma. Dimensions of electrode 102 and electrode 104 should be sufficient to generate and sustain plasma in gap 110. Electrode 102 may be configured to allow current to flow from the top of the electrode and out the bottom of the electrode. FIG. 4 depicts an embodiment of an electrode that includes one or more pointed elongated members. FIG. 5 depicts bottom view of an embodiment of an electrode that includes one or more convex elongated members. As shown in FIG. 4, elongated members 108 have a pointed end. Bottom end of elongated members 108 may be convex as shown in FIG. 5. A convex end or rounded end may allow for minimal corrosion and/or pitting of electrodes 102. Corrosion and/or pitting of the electrode surface may be caused by the electrical discharge during plasma generation. The shape of a bottom end of electrodes 102 may be any dimension suitable to sustain plasma in gap 110 and/or inhibit fouling of the electrode. Elongated members 108 may be hollow to allow fluid to pass into gap 110. Elongated members 108 may be affixed to support 116 using techniques know in the art (for example, glued, soldered, welded, or combinations thereof). Elongated members 108 and support 116 may be formed from one material. Electrode 102 may include from about 1 to about 100, from about 2 to about 50, or from about 3 to about 20 elongated members.

In some embodiments, electrodes may include openings in one or more surfaces of the electrode. For example, sides of the electrodes may include openings and/or a support of an electrode may include openings. A shape of openings in the electrodes may be any shape (for example, elliptical, spherical, rectangular, polygon, or combinations thereof). In other embodiments, a surface of the electrodes may include grooves. Openings in the electrodes may allow dispersal of fluid into the gap during plasma generation. For example, liquid feed may enter the gap through one of the electrodes and gas may exit through openings of the opposite electrode. FIG. 6 depicts an embodiment of an electrode that includes openings. As shown in FIG. 6, elongated members 108 may include openings 118. Support 116 may include inlets 120 to allow fluid to enter gap 110. In some embodiments, support 112 is a metal frit.

FIG. 7 depicts an embodiment of top view of electrode 104. Electrode 104 includes openings 118. Electrode 104 may be any shape and/or size sufficient to sustain plasma in gap 110. For example, electrode 104 may be a metal frit.

As shown in FIGS. 1-3 and 8-16, power supply 122 supplies sufficient current to electrodes 102 and 104 to produce plasma at temperatures of at most about 400° C., at most about 300° C., or at most about 200° C. In some embodiments, the power supply may supply direct current, alternating current, or a combination of direct and alternating current. In some embodiments, temperature of the plasma and/or plasma reformer 100 ranges from ambient temperature (25° C.) to about 400° C., from about 50° C. to about 300° C., or from about 100° C. to about 200° C. Use of a low-temperature plasma allows for a “rapid start-up” of the plasma system because the system may not require a significant amount of time to obtain the temperature required to generate heat necessary to produce molecular hydrogen.

As shown, alternating current is supplied from power supply 122. AC power supply 122 may pulse the current between electrodes 102 and 104 to generate plasma. Pulsation of AC power may inhibit formation of hydrocarbons from liquid oxygenated hydrocarbons when the liquid oxygenated hydrocarbons contact the plasma generated by the pulsed AC power.

As plasma is generated in gap 110, feed 124 may be converted to gas stream 126. Gas stream 126 may exit plasma reformer through one or more ports. Gas stream 126 may include, but is not limited to, molecular hydrogen, hydrocarbons, carbon oxides, water, or mixtures thereof. As shown in FIGS. 1 and 8, feed 124 may enter plasma reformer through port 106 and/or port 106′. As shown in FIG. 1, feed 124 flows through and/or around electrode 102 and/or electrode 104 into gap 110. As shown, flow of feed 124 is parallel to perpendicular to electrode 104. As shown in FIG. 8, feed 124 flows through plasma reformer 100 into gap 110 parallel to electrode 104. It should be understood that feed may flow into gap 110 in any direction and through one or more ports in plasma reformer 100. Delivery of feed 124 to plasma reformer may be performed using any technique known in the art (for example, pumps, sprayers, atomizers, or combinations thereof).

In some embodiments, power supply 122 and plasma reformer 100 are connected to a controller. The controller may control operation of power supply 122 and plasma reformer 100. For example, the controller may control the pulse interval of the electrical current supplied to the electrodes and/or the flow of the feed to the plasma reformer.

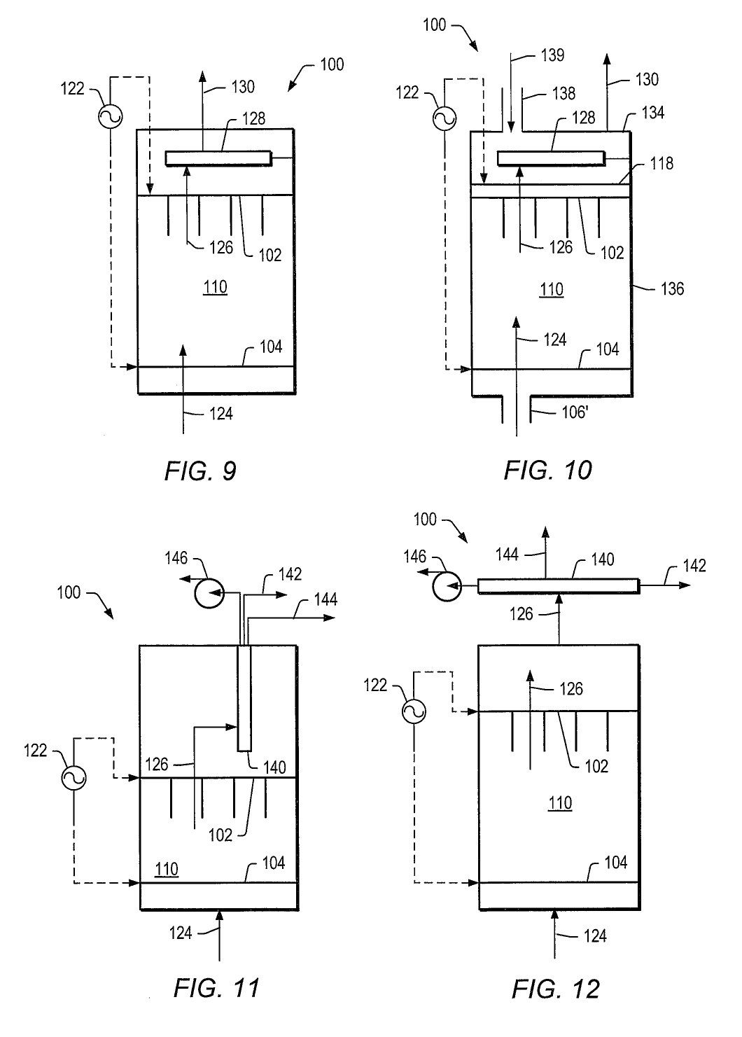

As shown in FIGS. 9, 10, 14-16, and 19, plasma reformer 100 may include catalyst system 128. Catalyst system 128 may be a water gas shift catalyst. Catalyst system 128 may include, but is not limited to, one or more metals from Column 7, Column 10, Column 14 of the Periodic Table and/or one or more compounds of one or more Column 7 metal, Column 10 metal, Column 14 metals, or mixtures thereof. Examples of metals include, copper, nickel, tin, platinum, zinc, rhenium, or mixtures thereof. An amount of metal may range from about 0.001 grams to about 0.3 grams, from about 0.01 grams to about 0.2 grams, or from about 0.05 to about 0.1 grams of metal per gram of catalyst. In some embodiments, catalyst system 128 may include one or more catalysts. For example, catalyst system 128 may include a platinum catalyst and a rhenium/platinum catalyst.

In some embodiments, the catalyst is a supported catalyst. The support may be one or more mineral oxides, alumina, titanium oxide, cerium oxide, or any suitable support for water shift gas catalysts. The metals may be impregnated on the support and/or mulled with support to form the water gas shift catalyst. In some embodiments, a surface area of the catalyst may range from about 50 m²/g to about 500 m²/g, from about 100 m²/g to about 400 m²/g, or from about 200 m²/g to about 300 m²/g. In certain embodiments, the catalyst may be an unsupported catalyst.

FIG. 9 depicts an embodiment of a plasma reformer system that includes catalyst system 128. As shown in FIG. 9, catalyst system 128 may be positioned proximate gap 110. Liquid feed 124 (for example, aqueous alcohol) may enter gap 110. Generation of plasma in gap 110 may convert liquid feed 124 to gas stream 126. Gas stream 126 may include gas and trace amounts of feed. As gas stream 126 is generated, it may contact catalyst system 128. Contact of gas stream 126 with catalyst system 128 in the presence of the liquid feed 124 may allow the carbon monoxide in gas stream 126 to be converted to carbon dioxide and molecular hydrogen to form molecular hydrogen enriched gas stream 130 as compared to the gas stream prior to contact with the catalyst system. Molecular hydrogen enriched stream 130 may include, but is not limited to, molecular hydrogen, carbon dioxide, hydrocarbons, and a minimal amount of liquid feed or mixtures thereof. In some embodiments, catalyst system 128 is positioned in a bed and the gas stream generated by reformation of liquid oxygenated hydrocarbons passes through the catalyst bed. In some embodiments, catalyst system 128 includes one or more catalysts in a stacked bed configuration.

Temperatures in plasma reformer 100 may range from about 25° C. to about 400° C., about 500° C. to about 300° C., or about 100° C. to about 200° C. Temperatures of plasma in plasma reformer 100 may be at most about 400° C., at most about 300° C. or at most about 200° C.

In contrast, to some plasma generator that require atmospheric pressure and/or sub-atmospheric pressure to sustain the plasma, plasma reformer may be operated at pressure greater than atmospheric while sustaining the plasma. Pressure in plasma reformer 100 may range from about 0.3 atm to about 5 atm, from about 0.5 atm to about 2 atm, or from about 1 atm to 3 atm. Operating plasma reformer 100 at elevated pressure may allow for generation of molecular hydrogen with minimal or substantially no hydrocarbon formation and/or carbon monoxide formation.

In some embodiments, one or more portions of plasma reformer 100 are insulated. Insulating portions of plasma reformer 100 may allow for more efficient generation of molecular hydrogen with minimal or substantially no carbon monoxide formation, and without the formation of coke and/or undesirable hydrocarbons in the plasma reformer.

FIG. 10 depicts an embodiment of a plasma reformer that includes a catalyst zone and a plasma zone. As shown in FIG. 10, catalyst system 128 is positioned in catalyst zone 134 proximate plasma zone 136. Catalyst zone 134 may be separated from plasma zone 136 by a membrane and/or other gas permeable material. In some embodiments, catalyst zone 134 is coupled to plasma reformer 100. Separation of catalyst zone 134 and plasma zone 136 may allow the reaction conditions in each zone to be varied. In some embodiments, catalyst zone 134 may include one or more catalysts. For example, catalyst zone 134 may be a stacked bed reactor. Contact of gas stream 126 with a first catalyst (for example, a platinum catalyst) and then a second catalyst (for example, a rhenium/platinum catalyst) may inhibit formation of hydrocarbons during the water gas shift reaction. Inhibition of hydrocarbon formation may enhance production of molecular hydrogen from a liquid feed.

Temperatures in plasma zone 136 may range from about 25° C. to about 400° C., about 50° C. to about 300° C., or about 100° C. to about 200° C. Temperatures of plasma in plasma reformer 100 may be at most about 400° C., at most about 300° C. or at most about 200° C. Pressure in plasma zone 136 may range from about 0.3 atm to about 5 atm, from about 0.5 atm to about 3 atm, or from about 1 atm to 2 atm. In some embodiments, one or more portions of plasma zone 136 are insulated.

Catalyst zone 134 may be operated at the same or different temperatures and pressures than plasma zone 136. Temperatures in catalyst zone 134 from about 100° C. to about 600° C., about 200° C. to about 500° C., or about 300° C. to about 400° C. Pressure in catalyst zone 134 may range from about 0.3 atm to about 10 atm, from about 2 atm to about 8 atm, or from about 3 atm to 5 atm. In some embodiments, one or more portions of catalyst zone 134 are insulated. Insulating portions of catalyst zone 134 may allow for more efficient conversion of carbon monoxide to carbon dioxide without the formation of coke and/or undesirable hydrocarbons in plasma zone 136. In some embodiments, operation of catalyst zone 134 at temperatures and/or pressures different from the temperatures and/or pressures in plasma zone 136 may allow more efficient generation of molecular hydrogen with minimal by-products.

As shown in FIG. 10, catalyst zone 134 includes inlet 138. Inlet 138 may allow liquid stream 139 (for example, water) to be injected into catalyst zone 134. Inlet 138, in some embodiments, is the same as port 106 shown in FIG. 1. Water may facilitate the conversion of carbon monoxide to carbon dioxide. Water may be delivered to catalyst zone 134 in manner that facilitates dispersion of the water in the gas present in the catalyst zone. For example, the water may be atomized, sprayed, and/or pumped into catalyst zone 134. Contact of gas stream 126 with catalyst system 128 generates molecular hydrogen enriched stream 130 as compared to the gas stream prior to contact with the catalyst system. Molecular hydrogen enriched stream 130 may exit plasma reformer and be used as an energy source.

In some embodiments, passing gas stream 126 and/or molecular hydrogen enriched stream 130 through a separation system may remove components from the gas streams and enrich or further enrich the molecular hydrogen content of the gas streams as compared to the streams entering the separation system. Molecular hydrogen enrichment of the gas streams may allow the molecular hydrogen stream to be used an energy source for devices that require molecular hydrogen as a source of fuel. For example, a molecular hydrogen enriched stream with low carbon oxide levels may be used in a PEM fuel cell. As shown in FIGS. 11 through 16, plasma reformer 100 includes separation system 140. Separation system 140 includes, but is not limited to, a membrane system, an electrical swing adsorption system, a pressure swing adsorption system, or combinations thereof. Separation system 140 may be in fluid communication with plasma reformer 100. In some embodiments, purifications system 140 may lower carbon dioxide levels in the generated gas to at most about 10 ppm, at most about 5 ppm, at most about 1 ppm per volume of gas.

In some embodiments, separation system 140 is a membrane system. The membrane system may include one or more membranes capable of separating molecular hydrogen, carbon dioxide, and/or hydrocarbons from the gas stream. Removal of selected gases from the reaction stream, may allow more molecular hydrogen to be generated and/or carbon monoxide converted to carbon dioxide. Membranes may be formed from a molecular hydrogen-permeable and/or molecular hydrogen selective material such as, but not limited to, a ceramic, carbon, metal, clay, or combinations thereof. Membranes may include one or more metals from Columns 5-10 of the Periodic Table and/or one or more compounds of one or more Columns 5-10 metals. Examples of metals include, but are not limited to, palladium, platinum, nickel, silver, tantalum, vanadium, yttrium, and/or niobium. Membranes may be supported on a porous substrate such as alumina, carbon, metal oxides, or combinations thereof. The support may separate the membrane from the plasma reformer. The separation distance and insulation properties of the support may help to maintain the membranes within a desired temperature range. In certain embodiments, a membrane may be manufactured from polyamines and/or polyamides. In some embodiments, membranes may be a carbon dioxide selective material.

FIG. 11 depicts plasma reformer with membrane separation system inside the reformer. As shown in FIG. 11, separation system 140 is positioned proximate gap 110. In some embodiments, separation system 140 removes selected gases continuously from gas stream 126 to produce molecular hydrogen stream 142 and carbon oxides stream 144. Carbon oxides stream 144 may include carbon monoxide and/or carbon dioxide. In some embodiments, separated gas stream 144 includes hydrocarbon gases. Pump 146 may assist removal of selected gases from generated gas stream by creating a pressure differential in separation system 140.

FIG. 12 depicts an embodiment of a plasma reformer with a membrane separation system coupled to the plasma reformer. As shown in FIG. 12, separation system 140 is proximate or adjacent to plasma reformer 100. Gas stream 126 exits plasma reformer 100 and enters separation system 140. In separation system 140, molecular hydrogen in gas stream 126 is separated to form molecular hydrogen stream 142 and separated gas stream 144. Molecular hydrogen stream 142 may include a minimal or trace amount of hydrocarbons and/or carbon oxides. Molecular hydrogen stream 142 may be enriched in molecular hydrogen as compared to the gas stream entering the membrane system. Molecular hydrogen stream 142 may be used as an energy source.

In some embodiments, separation system 140 may be an electrical swing adsorption system. U.S. Pat. Nos. 5,972,077; 5,925,168; and 5,912,424 to Judkins et al., each of which is incorporated herein by reference, describe electrical swing adsorption gas storage and delivery systems. Electrical swing adsorption may separate selected gases (for example, carbon dioxide and/or carbon monoxide) from the generated gas stream by adsorbing the selected gas on a sorption material. The sorption material may have enhanced sorption affinity for the selected gas upon application of current to the adsorption material. Adsorption materials used for electrical swing adsorption include, but are not limited to, carbon, activated carbon fiber composites, and/or molecular sieves. The adsorbed gas may be removed by applying a voltage different from the original voltage applied to the material. Applying a different voltage may raise the temperature of the material and allow the gas to desorb from the adsorption material. In some embodiments, pressure of the electrical swing adsorption system may be changed to remove the adsorbed component from the material. The desorbed material may be treated and/or sequestered.

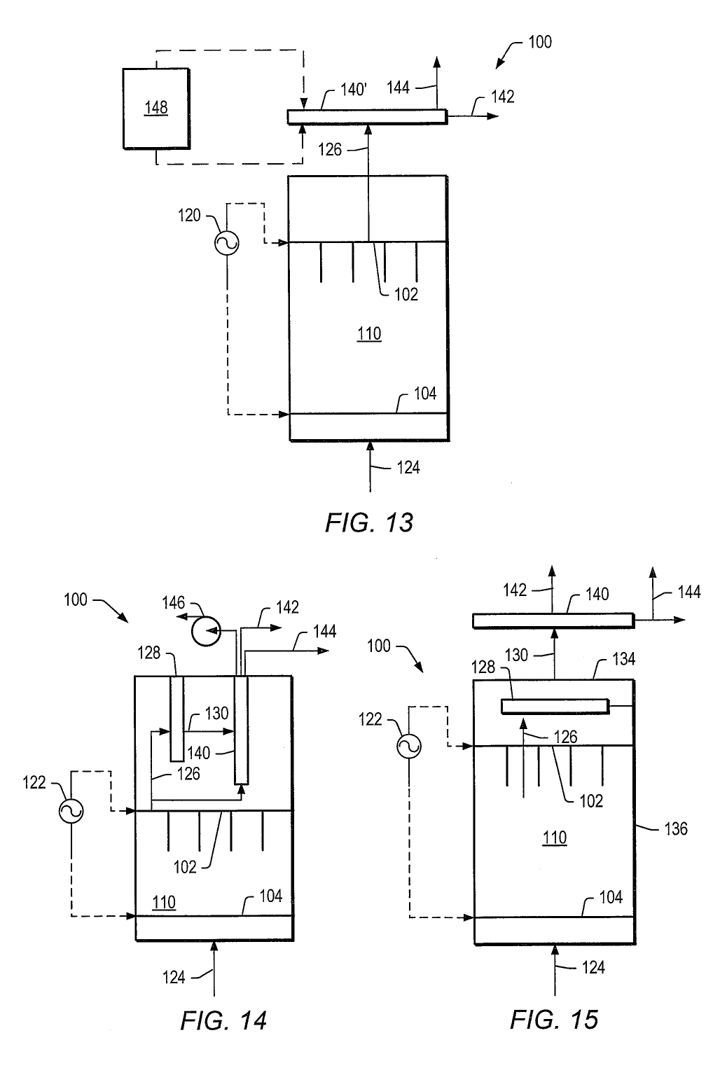

FIG. 13 depicts an embodiment of a plasma reformer with an electrical swing adsorption system. Referring to FIG. 13, generated gas stream 126 exits plasma reformer 100 and enters electrical swing adsorption separation system 140′. In electrical swing adsorption separation system 140′, electrically conductive adsorbent material is activated by current from power supply 148. Contact of gas stream 126 with the electrically conductive material may separate molecular hydrogen from gas stream 126 to form molecular hydrogen stream 142 and separated gas stream 144. Molecular hydrogen stream 142 may include a minimal amount of carbon oxides and/or hydrocarbons. Molecular hydrogen stream 142 may be enriched in molecular hydrogen as compared to the gas stream entering the electrical swing adsorption system. Separated gas stream 144 may include carbon oxides, hydrocarbons, oxygenated hydrocarbons, vaporized feed, water, or mixtures thereof.

In some embodiments, a high concentration of molecular hydrogen in the generated gas stream is desired. The combination of a water gas shift gas and separation system may produce molecular hydrogen streams that are suitable for use in devices that require high purity and/or high concentrations of molecular hydrogen. FIGS. 14-16 depict embodiments of catalyst systems and separations systems in combination with a plasma reformer.

FIG. 14 depicts plasma reformer that includes a catalyst system and a membrane separation system. As shown in FIG. 14, catalyst system 128 is positioned proximate gap 110 and membrane separation system 140. Contact of gas stream 126 with catalyst system 128 may produce molecular hydrogen enriched stream 130 as compared to the gas prior to contacting the catalyst. Molecular hydrogen enriched stream 130 may enter membrane separation system 140. In membrane separation system 140, molecular hydrogen may be separated from other components in the stream to form molecular hydrogen stream 142 and separated gas stream 144. Separated gas stream 144 may include carbon monoxide and/or carbon dioxide. Separated gas stream 144 may have an enriched molecular hydrogen content as compared to the gas stream entering membrane separation system 140. In some embodiments, separation system 140 removes selected gases continuously from gas stream 126 to produce molecular hydrogen stream 142 and separated gas stream 144. Pump 146 may assist removal of selected gases from generated gas stream 126 by creating a pressure differential in separation system 140.

FIG. 15 depicts an embodiment of a plasma reformer that includes a catalyst a membrane separation system coupled to the plasma reformer. As shown in FIG. 15, separation system 140 is proximate or adjacent to plasma reformer 100. Contact of gas stream 126 with catalyst system 128 may produce molecular hydrogen enriched gas stream 130. Molecular hydrogen enriched gas stream 130 may enter membrane separation system 140. The separation system may be any plasma reformer/membrane separation system described herein (for example, FIGS. 11, 12, 14, and 15). In separation system 140, molecular hydrogen may be separated from other components in the stream to form molecular hydrogen stream 142 and separated gas stream 144. Separated gas stream 144 may include carbon monoxide and/or carbon dioxide. In some embodiments, separation system 140 removes selected gases continuously from gas stream 126 to produce molecular hydrogen stream 142 and separated gas stream 144. In some embodiments, the separation system includes a pump to create a pressure differential to assist removal of gases from the plasma reformer. Molecular hydrogen stream 142 may be enriched in molecular hydrogen as compared to the gas stream entering the membrane system.

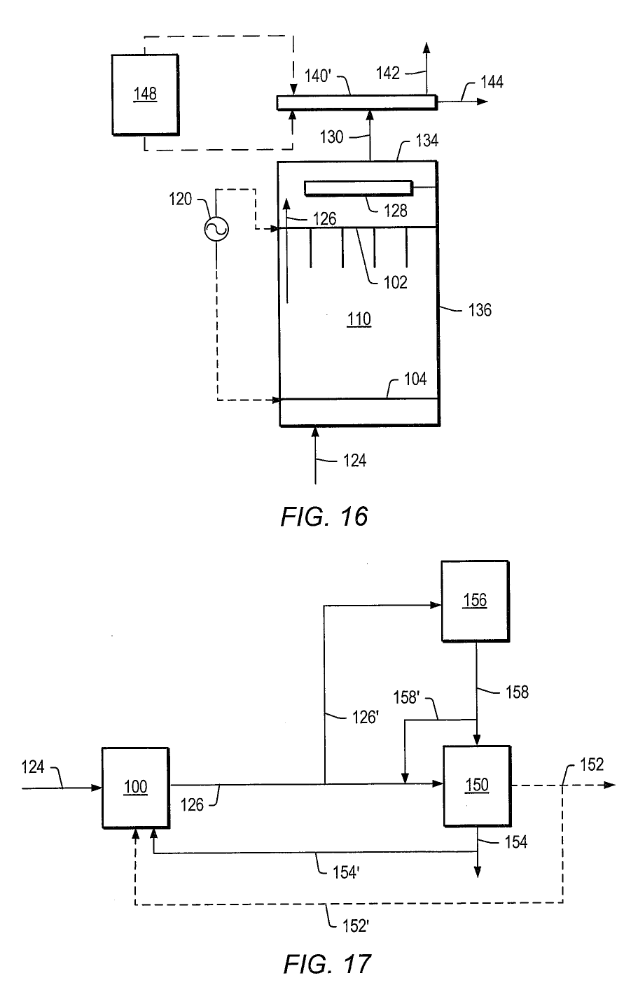

FIG. 16 depicts an embodiment of a plasma reformer that includes a catalyst and an electrical swing adsorption system. Referring to FIG. 16, catalyst system 128 is positioned in catalyst zone 134. Electrical swing adsorption system is positioned proximate plasma reformer 100. Contact of gas stream 126, generated in plasma zone 136 from liquid feed 124, with catalyst system 128 may produce molecular hydrogen enriched stream 130 as compared to the gas stream prior to contact with the catalyst system. Molecular hydrogen enriched stream 130 may enter separation system 140′. The separation system may be any plasma reformer/membrane electrical swing adsorption system described herein (for example, FIG. 13). In electrical swing adsorption separation system 140′, electrically conductive adsorbent material is activated by current from power supply 148. Contact of molecular hydrogen enriched gas stream 130 with the electrically conductive material may separate carbon dioxide from molecular hydrogen enriched gas stream 130 to form molecular hydrogen stream 142 and separated gas stream 144. Molecular hydrogen stream 142 may include a minimal amount of carbon oxides and/or hydrocarbons. Molecular hydrogen stream 142 may be enriched in molecular hydrogen as compared to the gas stream entering the electrical swing adsorption system. In some embodiments, membrane separation system 140 and electrical swing adsorption system 140′ may be used in tandem.

Plasma reformer systems described in FIGS. 1-16 may be used to generate molecular hydrogen (H₂) for fuel cells. FIG. 17 depicts a system that includes a plasma reformer system and a fuel cell. Plasma reformer 100 may be any plasma reformer system described herein (for example, plasma reformer described in FIGS. 1-3 and 9-10). As shown in FIG. 17, liquid feed 124 enters plasma reformer system 100. In plasma reformer 100, liquid feed 124 is converted to gas stream 126. Gas stream 126 enters fuel cell 150. Fuel cell 150 generates electricity 152 and water stream 154. Electricity 152′ and water stream 154′ may be recycled to plasma reformer system 100. Recycle of the generated electricity and water may enhance efficiency of the plasma reformer system.

Gas stream 126′ enters storage unit 156. Storage unit 156 may include one or more compressors to compress gas stream 126′. Compressors include mechanical and/or chemical compressors. In some embodiments, the chemical compressor is a metal hydride compressor. Stored gas streams 158,158′ exit storage unit 156 and enter fuel cell 150 and/or gas stream 126 when needed. The ability to generate and store molecular hydrogen may allow energy requirements in remote and/or isolated areas to be met.

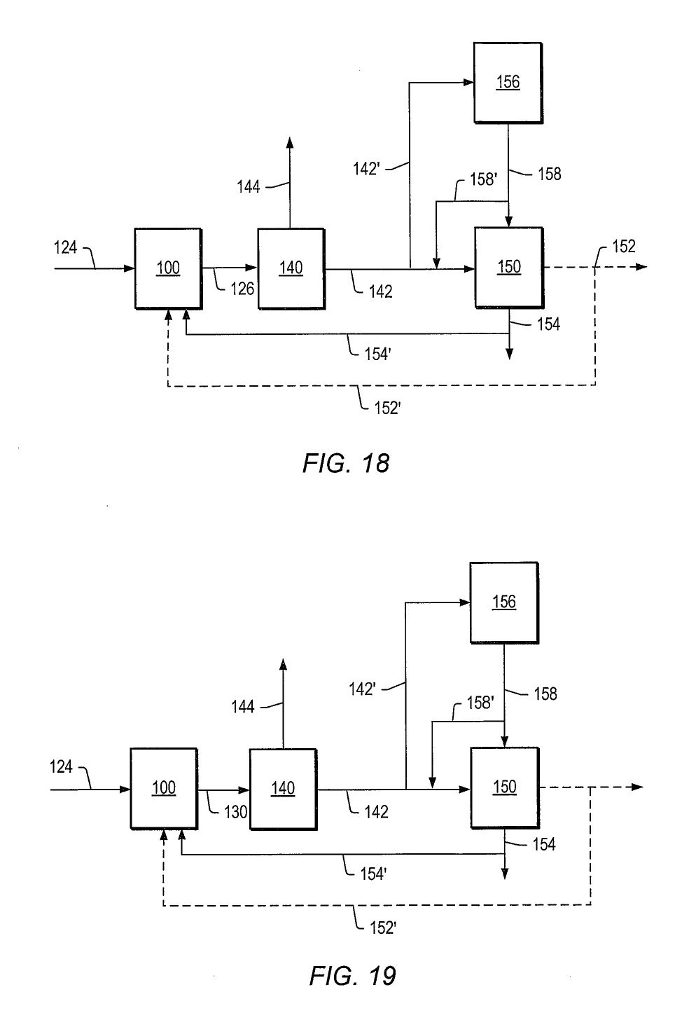

FIG. 18 depicts an embodiment of a system to produce molecular hydrogen that includes a plasma reformer, a membrane separation system, and a fuel cell. As shown in FIG. 18, liquid feed 124 enters plasma reformer system 100. Plasma reformer system 100 may be any plasma reformer system described herein (for example, plasma reformer systems described in FIGS. 1-3 and 8). In plasma reformer 100, liquid feed 124 contacts a plasma to form gas stream 126. Gas stream 126 exits plasma reformer 100 and enters membrane separation system 140. A plasma reformer-membrane separation system may be any system describe herein (for example, FIGS. 11, 12, 14 and 15). In membrane separation system 140, molecular hydrogen may be separated from gas stream 126 to form molecular hydrogen stream 142 and separated gas stream 144. Separated gas stream 144 may be burned, sequestered, and/or recycled to plasma reformer 100.

Molecular hydrogen stream 142 may enter fuel cell 150. Molecular hydrogen stream 142′ enters storage unit 156. Storage unit 156 may include one or more compressors to compress gas stream 142′. Compressors include mechanical and/or chemical compressors. In some embodiments, the chemical compressor is a metal hydride compressor. Stored gas streams 158,158′ exit storage unit 156 and enter fuel cell 150 and/or gas stream 142 when needed.

Fuel cell 150 generates electricity 152 and water stream 154. Electricity 152′ and water stream 154′ may be recycled to plasma reformer system 100.

FIG. 19 depicts an embodiment of a system to produce molecular hydrogen that includes a plasma reformer, a catalyst system, a membrane separation system, and a fuel cell. As shown in FIG. 19, liquid feed 124 enters plasma reformer system 100. In plasma reformer 100, liquid feed 124 contacts a plasma to form a gas stream The gas stream contacts catalyst system 128 as previously described herein (for example, plasma reformer systems as described in FIGS. 9 and 10) to form molecular hydrogen enriched gas stream 130 as compared to the gas stream prior to contact with the catalyst system. Molecular hydrogen enriched gas stream 130 and enters membrane separation system 140. In membrane separation system, molecular hydrogen may be separated from molecular hydrogen enriched gas stream 130 to form molecular hydrogen stream 142 and separated gas stream 144. Separated gas stream 144 may be burned, sequestered, and/or recycled to plasma reformer 100. In some embodiments, membrane separation system is positioned inside plasma reformer system 100 (see FIG. 14).

Molecular hydrogen stream 142 may enter fuel cell 150. Fuel cell 150 generates electricity 152 and water stream 154. Electricity 152′ and water stream 154′ may be recycled to plasma reformer system 100. Molecular hydrogen stream 142′ may enter storage unit 156. Storage unit 156 may include one or more compressors to compress molecular hydrogen stream 142′. Stored molecular hydrogen streams 158,158′ exit storage unit 156 and enter fuel cell 150 and/or molecular hydrogen stream 142 when needed. Molecular hydrogen stream 142′ may enter storage unit 156. Storage unit 156 may include one or more compressors to compress molecular hydrogen stream 142′.

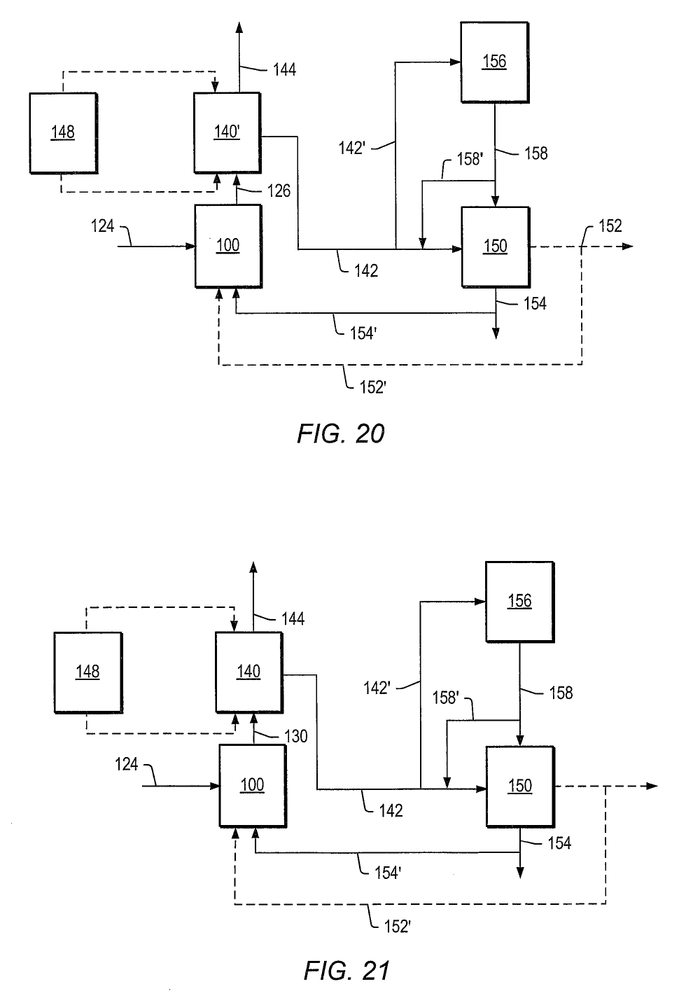

FIG. 20 depicts an embodiment of a system to produce molecular hydrogen that includes a plasma reformer, an electrical swing adsorption separation system, and a fuel cell. As shown in FIG. 20, liquid feed 124 enters plasma reformer system 100. Plasma reformer system 100 may be any plasma reformer system described herein (for example, plasma reformer systems described in FIGS. 1-3 and 8). In plasma reformer 100, liquid feed 124 contacts a plasma to form gas stream 126. Gas stream 126 exits plasma reformer and enters electrical swing adsorption separation system 140′. In electrical swing adsorption separation system 140′, molecular hydrogen may be separated from gas stream 126 to form molecular hydrogen stream 142 and separated gas stream 144. Molecular hydrogen stream 142 may enter fuel cell 150. Fuel cell 150 generates electricity 152 and water stream 154. Electricity 152′ and water stream 154′ may be recycled to plasma reformer system 100.

FIG. 21 depicts an embodiment of a system to produce molecular hydrogen that includes a plasma reformer, a catalyst system, an electric swing adsorption separation system, and a fuel cell. As shown in FIG. 21, liquid feed 124 enters plasma reformer system 100. In plasma reformer 100, liquid feed 124 contacts a plasma to form gas stream 126. Gas stream 126 contacts catalyst system 128 as previously described herein (for example, as described in FIGS. 9 and 10) to form molecular hydrogen enriched gas stream 130 as compared to the gas stream prior to contact with the catalyst system. Molecular hydrogen enriched gas stream 130 and enters electrical swing adsorption separation system 140′. In electrical swing adsorption separation system 140′, molecular hydrogen may be separated from molecular hydrogen enriched gas stream 130 to form molecular hydrogen stream 142 and separated gas stream 144. Molecular hydrogen stream 142 may enter fuel cell 150. Fuel cell 150 generates electricity 152 and water stream 154. Electricity 152′ and water stream 154′ may be recycled to plasma reformer system 100. Molecular hydrogen stream 142′ may enter storage unit 156. Stored molecular hydrogen streams 158,158′ exit storage unit 156 and enter fuel cell 150 and/or molecular hydrogen stream 142 when needed.

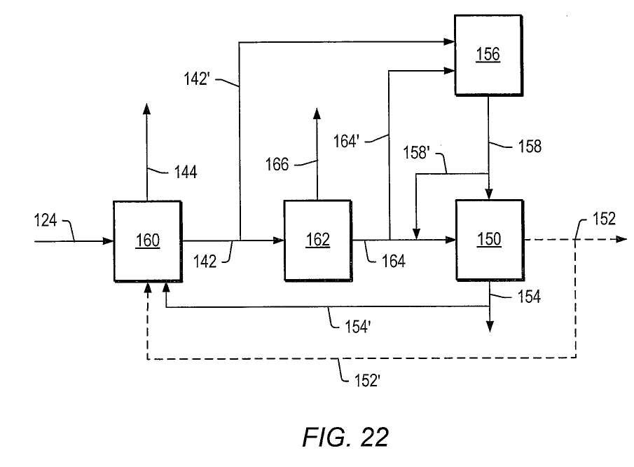

In some embodiments, purification of the molecular hydrogen stream generated from plasma reformer is necessary for use in stationary and/or mobile devices. FIG. 22 depicts a system that includes a plasma reformer system, a purification system, and a fuel cell. As shown in FIG. 22, liquid feed 124 enters plasma reformer system 160. Plasma reformer 160 may be any plasma reformer system and/or plasma reformer system in combination with a separation system described herein (for example, systems described in FIGS. 9-21). In plasma reformer system 160, liquid feed 124 may be converted to molecular hydrogen stream 142 and separated gas stream 144.

Molecular hydrogen stream 142 enters purification system 162. In purification system 162, small amounts and/or trace amounts of carbon dioxide and/or water may be removed from molecular hydrogen stream 124 to form purified molecular hydrogen stream 164 and carbon oxide/water stream 166. Carbon oxide/water stream 166 may be burned, sequestered and/or recycled to plasma reformer 160 and/or combined with separated gas stream 144.

A portion or all of molecular hydrogen stream 164 enters fuel cell 150. Fuel cell 150 generates electricity 152 and water stream 154. Electricity 152′ and water stream 154′ may be recycled to plasma reformer system 100. Molecular hydrogen stream 142′ and/or purified molecular hydrogen stream 162′ enter storage unit 156. Stored molecular hydrogen streams 158,158′ exit storage unit 156 and enter fuel cell 160 and/or molecular hydrogen stream 162 when needed. The ability to generate and/or store molecular hydrogen may allow the fuel cell to be operated in remote locations and/or during power outages.

### EXAMPLE

A non-limiting example of systems and methods to generate molecular hydrogen from a liquid feed using low-temperature plasma described herein is described below.

Example. A tubular reactor was equipped with two vertically oriented electrodes with a ½ inch quartz tube (plasma generating zone) positioned between the electrodes. The cathode electrode (¼″ stainless steel tube) was positioned at the bottom of the tubular reactor. The cathode electrode included an opening to allow generated gas to leave the reactor. The anode electrodes (10 1/16″ inch stainless steel needles) were positioned at the top of the tubular reactor. The anode electrodes were connected to a pump that delivered aqueous ethanol into the plasma-generating zone. Anode electrodes were connected to a high voltage amplifier (Trek 20/20C) equipped with a pulse signal input (HP), and the cathode electrode was grounded. The gap between the anode and cathode electrodes was 15 mm. Temperature of the plasma in the gap was estimated to be between 260° C. and 280° C. using an IR digital temperature probe.

Catalysts listed in TABLE 1 were positioned next to the plasma zone. In certain runs, as indicated in TABLE 1, the catalyst zone was insulated. Temperature in the catalyst zone was maintained at 300° C. Catalysts were prepared as described herein.

An aqueous solution of ethanol (35 vol % ethanol) was fed to the plasma reactor at the flow rates listed in TABLE 1. Plasma was generated under the following conditions: voltage RMS 3.93 kV; current RMS 2.25 kV; frequency 5.99 kHz; power RMS 3 W. Products generated from the reforming of ethanol by low-temperature plasma are listed in TABLE 1 and TABLE 2.

Pt/TiO₂ catalyst. The Pt/TiO₂ catalyst was prepared by the following method. TiO₂ (Degussa TiO₂ P25, Evonik Degussa, Germany) powder was impregnated with H₂PtCl₆ solution at room temperature for twelve hours to form a platinum/titanium oxide mixture. The platinum/titanium oxide mixture was dried at 100° C. for twelve hours and then calcined in air at 400° C. for four hours.

Re/Pt/TiO₂ catalyst. The Re/Pt/TiO₂ catalyst was prepared by the following method. TiO₂ (Degussa TiO₂ P25, Evonik Degussa, Germany) powder was impregnated with a NH₄ReO₄ solution at room temperature for one hour and then impregnated with a H₂PtCl₆ solution at room temperature for twelve hours to form a platinum/titanium oxide mixture. The rhenium/platinum/titanium oxide mixture was dried at 100° C. for twelve hours and then calcined in air at 400° C. for four hours.

TABLE 1

| Catalyst | Flow rate | H₂ | CO₂ | CO | CH₄ | C₂H₆ | |
|---|---|---|---|---|---|---|---|
| Amount | mL/min | Vol % | Vol % | Vol % | Vol % | Vol % | Insulated |
| None | 87.8 | 63.9 | 4.96 | 30 | 0.37 | 0.26 | |
| 1 gram 1% | 98.4 | 70.1 | 12.3 | 15.5 | 0.57 | 1.34 | No |
| Pt/TiO₂ | | | | | | | |
| 1 gram 1% | 102.5 | 74.2 | 20 | 4.3 | 0.64 | 0.79 | Yes |
| Pt/TiO₂ | | | | | | | |
| 1 gram 2% | 111.6 | 73.7 | 20.6 | 3.83 | 0.69 | 1.10 | No |
| Pt/TiO₂ | | | | | | | |
| 1 gram 2% | 89.5 | 69.8 | 21.5 | 4.09 | 3.2 | 1.38 | Yes |
| Pt/TiO₂ | | | | | | | |
| 2 gram 2% | 115.4 | 74.7 | 21.3 | 2.42 | 0.6 | 0.95 | Bottom portion |
| Pt/TiO₂ | | | | | | | |

TABLE 2

| | | EtOH | | | | | |
|---|---|---|---|---|---|---|---|
| | Flow rate | Conversion | Gas composition (%) | | | | |
| Catalyst Amount | (mL/min) | (%) | H₂ | CO₂ | C₂H₆ | CH₄ | CO |
| 1 gram Pt/TiO₂ | 103 | 94 | 74.2 | 20.0 | 0.79 | 0.64 | 4.30 |
| 0.6 gram of 1 wt % | 106 | 94.4 | 72.6 | 21.6 | 1.2 | 1.1 | 3.5 |
| Pt—Re/TiO₂ | | | | | | | |
| 0.4 gram Pt/TiO₂ and | 109 | 96.6 | 73.3 | 23.6 | 1.4 | 0.9 | 0.8 |
| 0.6 gram Re/Pt/TiO₂ | | | | | | | |

### Example 2

The plasma reformer as described in Example 1 was run without catalyst at 5 psig and 10 psig. The results of at experimental conditions, various pressures, and products formed are listed in TABLE 3.

TABLE 3

| Experiment conditions | 5 psig | 10 psig |
|---|---|---|
| H₂O/EtOH ratio | 3.24 | 3.24 |
| Feed rate (mmol/min) | 1.15 | 1.00 |
| Voltage RMS (kV) | 4.05 | 4.66 |
| Current RMS (mA) | 2.20 | 2.17 |
| Frequency (kHz) | 6.54 | 6.20 |
| Power RMS (W) | 2.97 | 3.51 |
| Summary | | |
| H₂ + CO Productivity (sccm) | 139.2 | 131.4 |
| H₂ selectivity | 111% | 120% |
| CO selectivity | 82% | 87% |
| CO₂ selectivity | 7% | 7% |
| HC selectivity | 11% | 6% |
| Reformer efficiency | 79% | 82% |

### Selectivity of COx=mole of product COx/(2×mole of converted ethanol)×100.

### Selectivity of H₂=mole of product H₂/(3×mole of converted ethanol)×100.

Converted ethanol was the total number of moles of ethanol in the following reactions:

C₂H₅OH+H₂O=2CO+4H₂

C₂H₅OH+H₂=2CH₄+H₂0

C₂H₅OH=C₂Hx+H₂O+yH₂,

which was back calculated from mole products CO, C₂Hx and CH₄. Amounts of CO, C₂Hx, and CH₄ were determined using on line gas chromatography with absolute calibrations. The conversion was then calculated based on the following formula:

Ethanol conversion=(mole ethanol converted)/mole ethanol×100, where mole ethanol input is calculated from the feed rate of ethanol and water mixture.

In this patent, certain U.S. patents and U.S. published patent applications have been incorporated by reference. The text of such U.S. patents and U.S. published patent applications, however, only incorporated by reference to the extent that no conflict exists between such text and the other statements and drawings set forth herein. In the event of such conflict, then any such conflicting text in such incorporated by reference U.S. patents and U.S. published patent applications is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A system for production of molecular hydrogen using a membrane separation system, comprising:
a plasma reformer configured to receive a liquid feed and produce a gas stream from the liquid feed, wherein the plasma reformer is configured generate a plasma having a temperature of at most about 400° C., and wherein the gas stream comprises molecular hydrogen and carbon oxides; and
a membrane separation system in fluid communication with the plasma reformer, wherein the membrane system is configured to separate at least a portion of the carbon oxides from the gas stream to produce a gas stream enriched in molecular hydrogen as compared to the gas stream entering the membrane separation system.

2. The system of claim 1, wherein the membrane comprises a molecular hydrogen-permeable material or a molecular hydrogen selective material.

3. The system of claim 1, wherein the membrane comprises one or more Columns 5-10 metals of the Periodic Table and/or one or more compounds of one or more Column 10 metals of the Periodic Table.

4. The system of claim 1, wherein the membrane comprises palladium, platinum, nickel, silver, tantalum, vanadium, yttrium, niobium, or mixtures thereof.

5. The system of claim 1, wherein the membrane comprises ceramic, carbon, metal oxides, or combinations thereof.

6. The system of claim 1, wherein the membrane comprises a support.

7. The system of claim 1, wherein the membrane comprises a support and the support comprises alumina.

8. The system of claim 1, wherein the membrane separation system is coupled to a fuel cell.

9. The system of claim 1, wherein the liquid feed comprises liquid oxygenated hydrocarbons.

10. The system of claim 1, wherein the liquid feed is ethanol.

11. The system of claim 1, wherein the liquid feed comprises at least 5 vol % oxygenated hydrocarbons based on the total volume of the liquid feed.

12. The system of claim 1, wherein the liquid feed comprises hydrocarbons.

13. The system of claim 1, wherein the plasma reformer comprises:
one or more elongated anode electrodes;
a cathode electrode positioned opposite one or more of the elongated anode electrodes; and
a current supply source configured to supply current to one or more of the elongated anode electrodes and the cathode electrode such that plasma is generated in a gap between the cathode and one or more of the elongated electrodes.

14. The system of claim 13, wherein the gap between the cathode and one or more of the elongated electrodes ranges from about 1 millimeter to about 100 millimeter.

15. The system of claim 13, wherein the plasma reformer has an inlet and an outlet and the liquid feed flows from the inlet to the outlet in a direction parallel to the cathode electrode.

16. The system of claim 13, wherein the plasma reformer has an inlet and an outlet and the liquid feed flows in a direction perpendicular to the cathode electrode.

17. The system of claim 13, wherein a shape of at least one of the discharge ends of at least one of the elongated anode electrodes is convex.

18. The system of claim 13, wherein the current is an alternating current.

19. The system of claim 13, wherein the current is direct current.

20. The system of claim 1, further comprising one or more power supplies configured to supply current to the plasma reformer and electrical swing adsorption system.

21. A method for producing molecular hydrogen using a membrane separation system, comprising:
contacting a liquid feed with plasma having a temperature of at most about 400° C. to produce a gas stream, wherein the gas stream comprises molecular hydrogen and carbon oxides; and
passing at least a portion of the gas stream through a membrane separation system coupled to the plasma reformer; wherein contact of the gas with one or more membranes of the membrane separation system removes at least a portion of the carbon oxides from the gas stream to produce a gas stream enriched in molecular hydrogen as compared to the gas stream entering the membrane separation system.

22. The method of claim 21, wherein the carbon oxides comprise carbon monoxide and carbon dioxide.

23. The method of claim 21, further comprising desorbing at least a portion of the carbon oxides from at least one of the membranes and providing at least a portion of the carbon oxides to the plasma reformer as a heat source.

24. The method of claim 21, wherein the liquid feed comprises oxygenated hydrocarbons.

25. The method of claim 21, further comprising providing at least a portion of the molecular hydrogen enriched gas stream to a fuel cell.

26. The method of claim 21, wherein the molecular hydrogen enriched gas stream comprises at most about 50 ppm by volume of carbon monoxide.
